(19) United States
(12) Patent Application Publication
(10) Pub. No.: US 2024/0167816 A1
(43) Pub. Date: May 23, 2024

(54) Laser-Level and Measuring Device

(71) Applicant: Guillermo Manica Garcia, Burlington, NC (US)

(72) Inventor: Guillermo Manica Garcia, Burlington, NC (US)

(21) Appl. No.: 18/513,865

(22) Filed: Nov. 20, 2023

Related U.S. Application Data
(60) Provisional application No. 63/426,861, filed on Nov. 21, 2022.

(51) Int. Cl. G01C 15/00

(52) U.S. Cl. CPC G01C 15/002

(57) ABSTRACT

A laser-level and measuring device is provided. The device is comprised of a rectangular body that is preferably made from a plastic material. The body is comprised of three openings from which a laser may send a beam through the body. A horizontal beam and two vertical beams perpendicular to the horizontal beam may display on a wall or other surface from which objects may be placed in a leveled manner. Each laser may also measure the distance between the surface on which the laser lands and the device. The distance measurement may then be shown on a display on the body of the device to be utilized by a user.

### CROSS-REFERENCE TO RELATED APPLICATION

The present application claims priority to, and the benefit of, U.S. Provisional Application No. 63/426,861, which was filed on Nov. 21, 2022, and is incorporated herein by reference in its entirety.

### FIELD OF THE INVENTION

The present invention relates generally to the field of leveling and measuring devices. More specifically, the present invention relates to a laser-level and measuring device with a horizontal beam and two vertical beams perpendicular to the horizontal beam that may display on a wall or other surface from which objects may be placed in a leveled manner. Each laser may also measure the distance between the surface on which the laser lands and the device. Accordingly, the present disclosure makes specific reference thereto. Nonetheless, it is to be appreciated that aspects of the present invention are also equally applicable to other like applications, devices, and methods of manufacture.

### BACKGROUND

There are many different styles and types of tools that can aid in the measurement or leveling of an object. When building something, it is imperative to consider the level of the object. When building multiple objects, it becomes even more important for the level and position of each object to be consistent. Using multiple tools for the measurement and level of these objects can consume time, leaving little time for other work and extending the duration of the job.

Therefore, there exists a long-felt need in the art for a device that can measure both the distance and level of an object at the same time. More specifically, there exists a long-felt need in the art for a laser-level and measuring device that can make leveling and positional measurements on any flat surface. Furthermore, there exists a long-felt need in the art for a laser-level and measuring device that can be easily adjusted to make accurate and precise level measurements, saving time and effort on a worksite.

The subject matter disclosed and claimed herein, in one embodiment thereof, comprises a laser-level and measuring device. The device is comprised of a generally rectangular body that is preferably made from a plastic material. The body is comprised of three openings. Each opening has a laser that sends a beam to provide a level line from which objects may be constructed or placed. Each laser may also measure the distance between the device and the surface on which the laser lands. The distance between the device and each surface is then shown on a display on the body of the device.

In this manner, the laser-level and measuring device of the present invention accomplishes all the foregoing objectives and provides a device that can measure both the distance and level of an object at the same time. More specifically, the laser-level and measuring device can aid a user in determining the position and level of an object on any flat surface. Furthermore, the laser-level and measuring device can be easily adjusted, saving time and effort when making level measurements.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a laser-level and measuring device primarily comprised of a body, a horizontal opening, a first vertical opening, a second vertical opening, and a display. The device is designed to display lines onto a flat surface that are level and appropriately spaced such that the construction of a project requiring accurate positional and level measurements may be completed efficiently.

The device is comprised of a generally rectangular body preferably made of a plastic or lightweight metal material. The body may be comprised of a mounting bracket in one potential embodiment that allows the device to be attached to a wall or other surface. The body is further comprised of a horizontal opening and two vertical openings. The horizontal opening is comprised of a first laser that may send a horizontal beam onto a wall or other surface. The first laser may be positioned such that the horizontal beam is level and can measure the distance between the device and the surface on which the laser points. The first vertical opening is further comprised of a second laser that may send a first vertical beam onto a wall or other surface, preferably the ceiling. The second vertical opening is further comprised of a third laser that may send a second vertical beam onto a wall or other surface, preferably the floor. Both the first vertical beam and the second vertical beam may be perpendicular to the horizontal beam and can measure the distance between the device and the surface at which they are pointed.

The body of the device is further comprised of a button that can turn the device on or off. The button may turn all the lasers on or allow the user to turn any combination of lasers on. Once a beam from a laser hits a surface, a display on the body outputs the distance between the device and the wall at which the laser is pointed at. The device may be further comprised of a battery that is preferably rechargeable using a charging port on the surface of the body.

The present invention is also comprised of a method of using the device. First, a device is provided comprised of a body, a horizontal opening, a first vertical opening, a second vertical opening, and a display. Then, a button is pressed, turning on the first laser, the second laser, the third laser, or some combination of the first, second, and third lasers. Then, the first laser creates a 180-degree line on the wall and the second laser and the third laser each create a line that is perpendicular to the line created by the first laser. Next, an object may be constructed or placed such that it is level.

The present invention is also comprised of a second method of using the device. First, a device is provided comprised of a body, a horizontal opening, a first vertical opening, a second vertical opening, and a display. Then, a button is pressed, turning on the first laser, the second laser, the third laser, or some combination of the first, second, and third lasers. Then, a user may read the display to determine the distance between the device and the object to which the laser is pointed onto. Next, the leveling function of the device may be used once the appropriate distance is measured.

Accordingly, the laser-level and measuring device of the present invention is particularly advantageous as it provides a device that can measure both the distance and level of an object at the same time. More specifically, the laser-level and measuring device can be easily adjusted, allowing a user to quickly make accurate and precise length and level measurements. Furthermore, the laser-level and measuring device can assist a user in determining the proper positioning and level of an object on any surface. In this manner, the laser-level and measuring device overcome the limitations of existing leveling and measuring devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a laser-level and measuring device of the present invention in accordance with the disclosed architecture;

FIG. 2 illustrates a front view of one potential embodiment of a laser-level and measuring device of the present invention while being used on a wall in accordance with the disclosed architecture;

FIG. 3 illustrates a flowchart of a method of using one potential embodiment of a laser-level and measuring device of the present invention in accordance with the disclosed architecture; and

FIG. 4 illustrates a flowchart of a method of using one potential embodiment of a laser-level and measuring device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can measure both the distance and level of an object at the same time. More specifically, there exists a long-felt need in the art for a laser-level and measuring device that can make leveling and positional measurements on any flat surface. Furthermore, there exists a long-felt need in the art for a laser-level and measuring device that can be easily adjusted to make accurate and precise level measurements, saving time and effort on a worksite.

The present invention, in one exemplary embodiment, is comprised of a laser-level and measuring device. The device is primarily comprised of a body, a horizontal opening, a first vertical opening, a second vertical opening, and a display. The device is designed to display lines onto a flat surface that are level and appropriately spaced such that the construction of a project requiring accurate positional and level measurements may be completed efficiently.

More specifically, the device is comprised of a generally rectangular body that is preferably made from a plastic or lightweight metal material. In one potential embodiment, the body may be comprised of a mounting bracket, an opening, and a fastener that allow the device to be attached to a wall or other surface. The mounting bracket may attach directly to the body whereas the fastener may pass through the opening and attach to the wall. The body is further comprised of a horizontal opening which is further comprised of a first laser and a horizontal beam. The first laser sends the horizontal beam through the horizontal opening, providing a user with a level line across the wall from which the user may use to construct or place an object.

In addition, the body is comprised of a first vertical opening and a second vertical opening. The first vertical opening is further comprised of a second laser and a first vertical beam. The second vertical opening is further comprised of a third laser and a second vertical beam. The first vertical beam and the second vertical beam, in one potential embodiment, may display two lines on the wall, one that begins at the elevation of the horizontal beam and continues upwards along the wall and one that begins at the elevation of the horizontal beam and continues downwards along the wall. However, the first vertical beam and the second vertical beam may each span the vertical length of the entire wall and/or be positioned at any place along the wall, in differing embodiments. In all embodiments, each vertical beam may remain perpendicular to the horizontal beam.

The body of the device may further be comprised of at least one button. By pressing the button, the device may be powered on, sending stored energy from a battery to the device. The battery may store energy from a charging port in which a connector, preferably a USB connector, may be inserted. In differing embodiments, the button may be comprised of a singular button to control all three lasers or a plurality of buttons each responsible for a singular task. The color of each laser may be any color. In one potential embodiment, the button may be used to change the color of each laser to the preference of the user. Further, the body is comprised of a display. By sending pulses of laser light, the display may show the distance reading of each laser by measuring the amount of time it takes for the reflection of each laser pulse to reflect off the wall and return to the device.

The present invention is also comprised of a method of using the device. First, a device is provided comprised of a body, a horizontal opening, a first vertical opening, a second vertical opening, and a display. Then, a button is pressed, turning on the first laser, the second laser, the third laser, or some combination of the first, second, and third lasers. Then, the first laser creates a 180-degree line on the wall and the second laser and the third laser each create a line that is perpendicular to the line created by the first laser. Next, an object may be constructed or placed such that it is level.

The present invention is also comprised of a second method of using the device. First, a device is provided comprised of a body, a horizontal opening, a first vertical opening, a second vertical opening, and a display. Then, a button is pressed, turning on the first laser, the second laser, the third laser, or some combination of the first, second, and third lasers. Then, a user may read the display to determine the distance between the device and the object to which the laser is pointed onto. Next, the leveling function of the device may be used once the appropriate distance is measured.

Accordingly, the laser-level and measuring device of the present invention is particularly advantageous as it provides a device that can measure both the distance and level of an object at the same time. More specifically, the laser-level and measuring device can provide aid to a user, allowing for the proper positioning and level of any object on any surface. Furthermore, the laser-level and measuring device are adjustable, allowing a user to quickly make accurate and precise length and level measurements. In this manner, the laser-level and measuring device overcomes the limitations of existing leveling and measuring devices known in the art.

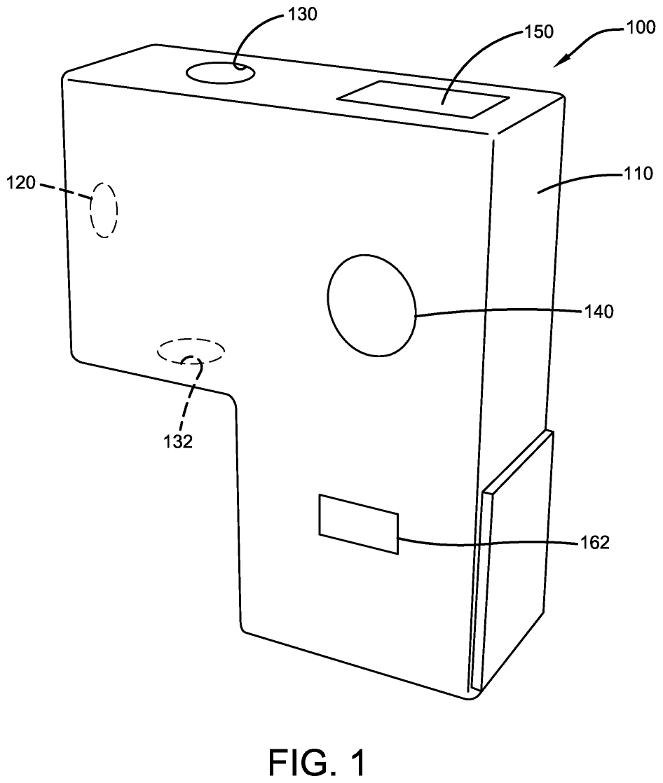

Referring initially to the drawings, FIG. 1 illustrates a perspective view of one potential embodiment of a laser-level and measuring device 100 of the present invention in accordance with the disclosed architecture. The device 100 is primarily comprised of a body 110, a horizontal opening 120, a first vertical opening 130, a second vertical opening 132, and a display 150. The device 100 is designed to display lines onto a flat surface that are level and appropriately spaced such that the construction of a project requiring accurate positional and level measurements may be completed efficiently.

The body 110 of the device 100 may be of any shape but is preferably generally rectangular. Further, the device may be made from any material, such as a metal, but is preferably made from a plastic material, such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, etc. The body 110 may be comprised of at least one mounting bracket 112 which is further comprised of at least one opening 114 and an at least one fastener 116. The fastener 116 may secure the device 100 to a wall 10 by passing through the opening 114 and attaching to the wall 10. The fastener 116 may be any fastener known in the art, such as an adhesive, a spike, a screw, a bolt, a magnet, etc. The fastener 116, in another embodiment, may also be fixedly attached to the body 110 of the device 100.

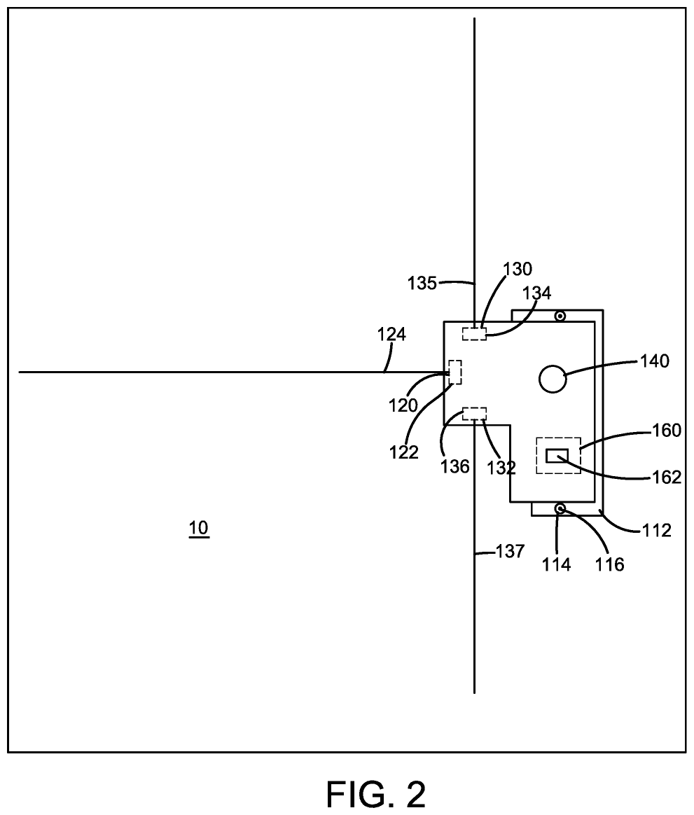

FIG. 2 illustrates a front view of one potential embodiment of a laser-level and measuring device 100 of the present invention while being used on a wall 10 in accordance with the disclosed architecture. The body 110 is further comprised of a horizontal opening 120, a first vertical opening 130, and a second vertical opening 132. The horizontal opening 120 is further comprised of a first laser 122 that produces at least one horizontal beam 124. The first laser 122 may send a horizontal beam 124 through the horizontal opening 120 such that a horizontal line may be displayed on a wall 10 for leveling purposes.

The first vertical opening 130 is further comprised of a second laser 134 that emits a first vertical beam 135. The second vertical opening 132 is further comprised of a third laser 136 that emits a second vertical beam 137. In the preferred embodiment of the device 100, the first opening 130 and second opening 132 face opposing directions. The second laser 134 and the third laser 136 can provide distance measurements from the device 100 to a ceiling or floor directly above or below, respectively. In one potential embodiment, the second laser 134 and the third laser 136 can provide vertical lines perpendicular to the horizontal line created by the first laser 122 to aid in the positioning/leveling of an object.

The body 110 of the device 100 may further be comprised of at least one button 140. The button 140 may be pressed to control the activation of the first laser 122, the second laser 134, the third laser 136, or some combination of the first laser 122, the second laser 134, and the third laser 136. The button 140 may further control the color of the horizontal beam 124, the first vertical beam 135, or the second vertical beam 137. Each beam 124,135,137 may be any fixed color such that it may not change or be customizable to the preference of the user in differing embodiments. Preferably, the top surface of the body 110 is also comprised of a display 150 that displays the distance between the device 100 and the end of each beam 124,135,137 to allow a user to achieve vertical and horizontal measurements.

During use, each laser 122,134,136 sends out pulses of light to form a beam 124,135,137. These pulses of light may reach a surface and reflect from that surface to the device 100. The device 100 may measure the time it takes for a pulse of light to reflect from a surface in order to determine the distance between the device 100 and the surface. Each distance measurement from each laser 122,134,136 may then be shown on the display 150 to be used by the user.

A battery 160 of the device 100 provides power to each laser 122,134,136 and the display 150 and may be charged by inserting a charging cord into a charging port 162. The battery 160 may be a disposable battery or a rechargeable battery in the form of an alkaline, nickel-cadmium, nickel-metal hydride battery, etc., such as any 3V-12 volt DC battery or other conventional batteries such as A, AA, AAA, etc., that supply power to the device 100. Throughout this specification, the term “battery” may be used interchangeably to refer to one or more wet or dry cells or batteries of cells in which chemical energy is converted into electricity and used as a source of DC power. References to recharging or replacing the battery 160 may refer to recharging or replacing individual cells, individual batteries of cells, or a package of multiple battery cells as is appropriate for any given battery technology that may be used. The charging port 162 may be compatible with any type of charging port typically used in rechargeable batteries but is preferably a USB port. The battery 160 may then supply power to the device 100.

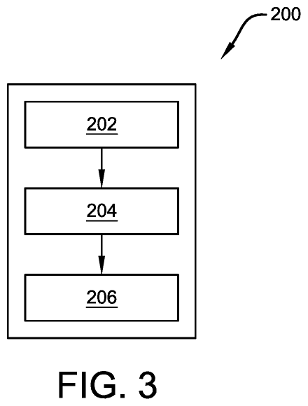

The present invention is also comprised of a method 200 of using the device 100, as seen in FIG. 3. First, a device 100 is provided comprised of a body 110, a horizontal opening 120 with a first laser 122, a first vertical opening 130 comprised of a second laser 134, a second vertical opening 132 comprised of a third laser 136, and a display 150 [Step 202]. Then, a button 140 is pressed to turn on a first laser 122, a second laser 134, a third laser 136, or some combination of the first 122, second 134, and third 136 lasers of the device 100 [Step 204]. As a result, the first laser 122 creates a 180-degree beam 124 on the wall and the second laser 134 and the third laser 136 each create opposing vertical beams 135,137 which are perpendicular to the line created by the first laser 122. Next, an object may be constructed or placed on said wall (or other surface) such that it is level using the beams of each laser 122,134,136 as a leveling guide [Step 206].

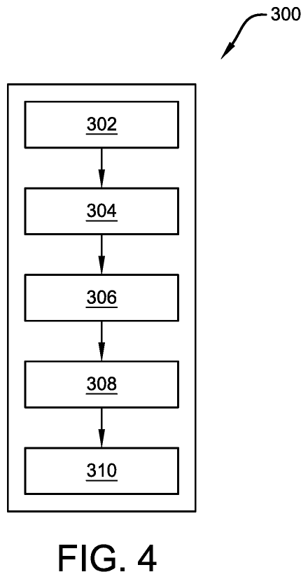

The present invention is also comprised of a second method 300 of using the device 100, as seen in FIG. 4. First, a device 100 is provided comprised of a body 110, a horizontal opening 120 with a first laser 122, a first vertical opening 130 comprised of a second laser 134, a second vertical opening 132 comprised of a third laser 136, and a display 150 [Step 302]. Then, a button 140 is pressed to turn on the first laser 122, the second laser 134, the third laser 136, or some combination of the first 122, second 134, and third 136 lasers [Step 304]. Then, a user may read the display 150 to determine the distance between the device 100 and the object or surface onto which a beam 124,135,137 of each laser 122,134,136 is pointed and reflects to the device 100 from [Step 306]. In a further step, the leveling function of the device 100 may be used once the appropriate distance is measured, as described in the above method 200 [Step 308].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “laser-level and measuring device” and “device” are interchangeable and refer to the laser-level and measuring device 100 of the present invention.

Notwithstanding the foregoing, the laser-level and measuring device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the laser-level and measuring device 100 as shown in the FIGS. are for illustrative purposes only, and that many other sizes and shapes of the laser-level and measuring device 100 are well within the scope of the present disclosure. Although the dimensions of the laser-level and measuring device 100 are important design parameters for user convenience, the laser-level and measuring device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laser-level and measuring device comprising:
a body comprised of a first horizontal opening, a first vertical opening, a second vertical opening, and a display;
a first laser positioned within the first horizontal opening;
a second laser positioned within the first vertical opening; and
a third laser positioned within the second vertical opening.

2. A laser-level and measuring device of claim 1, wherein the direction of the second laser opposes the direction of the third laser.

3. A laser-level and measuring device of claim 1, wherein the first laser is positioned perpendicular to the second laser and the third laser.

4. A laser-level and measuring device of claim 1, wherein the display shows a distance measured by the first laser, the second laser, or the third laser.

5. A laser-level and measuring device of claim 1, wherein the first laser emits a first laser beam.

6. A laser-level and measuring device of claim 1, wherein the second laser emits a second laser beam.

7. A laser-level and measuring device of claim 1, wherein the third laser emits a third laser beam.

8. A laser-level and measuring device of claim 1 further comprised of a button.

9. A laser-level and measuring device of claim 8, wherein the button activates the first laser, the second laser, or the third laser.

10. A laser-level and measuring device of claim 1 further comprised of a battery.

11. A laser-level and measuring device comprising:
a body comprised of a mounting bracket, a first horizontal opening, a first vertical opening, a second vertical opening, and a display;
a first laser positioned within the first horizontal opening;
a second laser positioned within the first vertical opening; and
a third laser positioned within the second vertical opening.

12. A laser-level and measuring device of claim 11, wherein the mounting bracket is comprised of an opening.

13. A laser-level and measuring device of claim 11, wherein the mounting bracket is comprised of a fastener.

14. A laser-level and measuring device of claim 11, wherein a first laser beam emitted from the second laser is emitted in an opposite direction as a second laser beam from the third laser.

15. A laser-level and measuring device of claim 11 further comprised of a rechargeable battery.

16. A laser-level and measuring device of claim 15, wherein the rechargeable battery is comprised of a charging port.

17. A method of using a laser-level and measuring device, the method comprising the following steps:
providing a laser-level and measuring device comprised of a display, a first vertical opening comprised of a first vertical laser, a second vertical opening comprised of a second vertical laser, and a horizontal opening comprised of a horizontal laser, the horizontal opening positioned perpendicular to the first vertical laser and to the second vertical laser; and
pressing a button of the laser-level and measuring device to turn on the first vertical laser, the second vertical laser, or the third vertical laser.

18. A method of using a laser-level and measuring device of claim 17 further comprised of a step of reading a measurement from the first vertical laser, the second vertical laser, or the third vertical laser on a display of the laser-level and measuring device.

19. A method of using a laser-level and measuring device of claim 17 further comprised of a step of placing an object on a wall such that the object is level in accordance with a horizontal laser beam produced by the horizontal laser.

20. A method of using a laser-level and measuring device of claim 17, wherein the horizontal laser produces a horizontal laser beam that is perpendicular to a first vertical laser beam produced by the first vertical laser and to a second vertical laser beam produced by the second vertical laser.
